(19) United States
(12) Patent Application Publication
(10) Pub. No.: US 2020/0177582 A1
(43) Pub. Date: Jun. 4, 2020

(54) NETWORK SYSTEM, INFORMATION PROCESSING APPARATUS, AND AUTHENTICATION METHOD

(71) Applicant: Ricoh Company, Ltd., Tokyo (JP)

(72) Inventor: KAZUKI KITAZAWA, Kanagawa (JP)

(73) Assignee: Ricoh Company, Ltd., Tokyo (JP)

(21) Appl. No.: 16/599,326

(22) Filed: Oct. 11, 2019

(30) Foreign Application Priority Data
Nov. 29, 2018 (JP) 2018-224220

(51) Int. Cl. H04L 29/06

(52) U.S. Cl. CPC H04L 63/0853; H04L 63/0861

(57) ABSTRACT

A network system includes: a memory to store an information table storing a plurality of terminal identification information identifying a plurality of information terminals respectively in association with a plurality of face information; an authentication server disposed on a network; a camera; and an access point that allows one or more of the plurality of information terminals to connect to the network. The access point includes first circuitry configured to: in response to receiving a connection request to the network from a particular information terminal, determine whether there is association between information obtained based on a face image captured by the camera and information acquired from the particular information terminal; and permit the particular information terminal to connect to the network based on determination that there is the association. The authentication server includes second circuitry configured to perform an authentication process for the particular information terminal.

### CROSS-REFERENCE TO RELATED APPLICATION

This patent application is based on and claims priority pursuant to 35 U.S.C. § 119(a) to Japanese Patent Application No. 2018-224220, filed on Nov. 29, 2018, in the Japan Patent Office, the entire disclosure of which is hereby incorporated by reference herein.

### BACKGROUND

### Technical Field

The present disclosure relates to a network system, and information processing apparatus and an authentication method.

### Description of Related Art

A remote conference system is known that conducts a conference by connecting information terminals such as personal computers (PC) or mobile devices to a network. Such remote conference system includes a conference apparatus such as an electronic whiteboard and a videoconference apparatus. Such remote conference system further includes a wireless local area network (LAN). The information terminal connects to an access point to use the network, which allows the information terminal to participate in the videoconference.

### SUMMARY

According to an embodiment, a network system includes: a memory to store an information table storing a plurality of terminal identification information identifying a plurality of information terminals respectively in association with a plurality of face information; an authentication server disposed on a network; a camera; and an access point that allows one or more of the plurality of information terminals to connect to the network. The access point includes first circuitry configured to: in response to receiving a connection request to the network from a particular information terminal, determine whether there is association between information obtained based on a face image captured by the camera and information acquired from the particular information terminal that has sent the connection request; and permit the particular information terminal that has sent the connection request to connect to the network based on determination that there is the association. The authentication server includes second circuitry configured to perform an authentication process for the particular information terminal that is permitted to connect to the network.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a system configuration including an electronic whiteboard and an authentication server, according to an embodiment of the present disclosure;

FIG. 2 is a schematic diagram illustrating how participants attending a meeting are imaged by a camera of the electronic whiteboard, according to an embodiment of the present disclosure;

FIG. 3 is a block diagram illustrating a hardware configuration of the electronic whiteboard, according to an embodiment of the present disclosure;

FIG. 4 is a block diagram illustrating a hardware configuration of the authentication server, according to an embodiment of the present disclosure;

FIG. 5 is a diagram illustrating a data structure of information table in the authentication server, according to an embodiment of the present disclosure;

FIG. 6 is a block diagram illustrating the functional configurations of the electronic whiteboard and the authentication server, according to the first embodiment of the present disclosure;

FIG. 7 is a flowchart illustrating processes in a control operation performed by the electronic whiteboard, according to the first embodiment of the present disclosure;

FIG. 8 is a flowchart illustrating processes in a control operation performed by the authentication server, according to the first embodiment of the present disclosure;

FIG. 9 is a sequence diagram illustrating an operation from when a PC is connected to the electronic whiteboard to when the PC is authenticated, according to an embodiment of the present disclosure;

FIG. 10 is a block diagram illustrating the functional configurations of the electronic whiteboard and the authentication server, according to the second embodiment of the present disclosure;

FIG. 11 is a flowchart illustrating processes in a control operation performed by the electronic whiteboard, according to the second embodiment of the present disclosure;

FIG. 12 is a flowchart illustrating processes in a control operation performed by the authentication server, according to the second embodiment of the present disclosure;

FIG. 13 is a flowchart illustrating processes in a control operation performed by the electronic whiteboard, according to the third embodiment of the present disclosure;

FIG. 14 is a flowchart illustrating processes in a control operation performed by the electronic whiteboard, according to the fourth embodiment of the present disclosure; and

FIG. 15 is a flowchart illustrating processes in a control operation performed by the authentication server, according to the fourth embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

A description is now given of embodiments of a network system and an authentication method, with reference to drawings. In the following embodiments, a description is of an example case where an access point is a part of functions of an electronic whiteboard. Further, in the following embodiments, a description is given of a case where a personal computer (PC) is an example of an information terminal. The present disclosure, however, is not limited to the following embodiments, and the constituent elements of the following embodiments include those which can be easily conceived by those skilled in the art, those being substantially the same ones, and those being within equivalent ranges. Furthermore, various omissions, substitutions, changes and combinations of the constituent elements can be made without departing from the gist of the following embodiments.

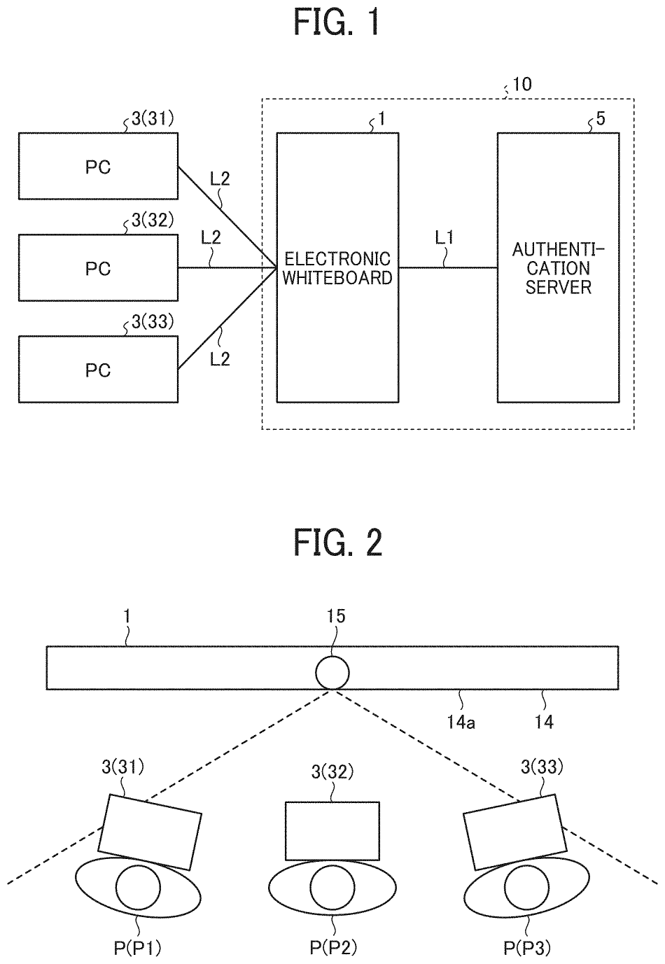

First, a description is given of a network system 10. FIG. 1 is a diagram illustrating an example of a network system according to an embodiment of the present disclosure. As illustrated in FIG. 1, the network system 10 includes, for example, an electronic whiteboard 1 and an authentication server 5. The electronic whiteboard 1 and the authentication server 5 are communicably connected to each other via a communication line L1 such as a local area network (LAN). Further, each of a plurality of personal computers (PCs) 3 can be communicable with the electronic whiteboard 1 by connecting to an access point such as a wireless LAN. In the embodiment, the following description is given on the assumption that three PCs 3, that is, a PC 31, a PC 32 and a PC 33 are connected to the access point.

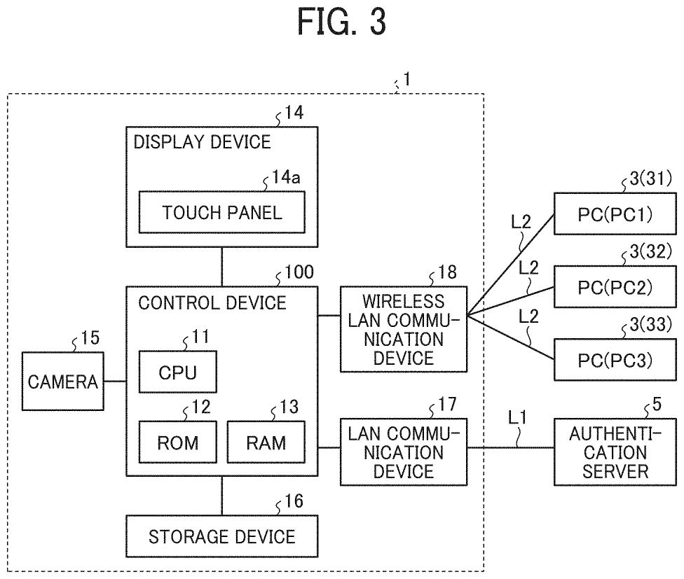

For example, one electronic whiteboard 1 is provided in one meeting room. The electronic whiteboard 1 includes a display device 14 having a touch panel 14a (see FIG. 3). The electronic whiteboard 1 displays various information. A user can draw characters, figures and the like on the display device 14 of the electronic whiteboard 1. Participants participating in a remote conference conduct the meeting while drawing characters or figures on the electronic whiteboard 1. The electronic whiteboard 1 transmits information to each of the PCs 3 connected to the access point. Each of the PCs 3 displays the received information on its display. Further, the electronic whiteboard 1 displays information received from the PCs 3.

The electronic whiteboard 1 includes a camera 15 provided in the upper center thereof. The camera 15 captures a face image of a participant who participates in the meeting by using the electronic whiteboard 1. The camera 15 is provided on the display device 14 side of the electronic whiteboard 1. The camera 15 captures face images of participants P who look in the direction of the display device 14 of the electronic whiteboard 1. FIG. 2 is a schematic diagram illustrating a state in which one or more participants P participating in the meeting are imaged by the camera 15 of the electronic whiteboard 1. In FIG. 2, the camera 15 can capture three face images of a participant P1 having a PC 31, a participant P2 having a PC 32, and a participant P3 having a PC 33. The participants P1, P2, and P3 conduct the meeting while touching the touch panel 14a with a stylus or the like to draw characters and figures on the display device 14 of the electronic whiteboard 1.

The electronic whiteboard 1 displays information displayed on the PC 31 of the participant P1, the PC 32 of the participant P2, and the PC 33 of the participant P3 on the display device 14. Further, the electronic whiteboard 1 can divide a display area on the display device 14 into plural areas and display information displayed on the PC 31, PC 32, and PC 33 in the plural areas respectively.

Next, a description is given of a hardware configuration of the electronic whiteboard 1. FIG. 3 is a block diagram illustrating a hardware configuration of the electronic whiteboard 1. As illustrated in FIG. 3, the electronic whiteboard 1 includes a central processing unit (CPU) 11, a read only memory (ROM) 12, a random access memory (RAM) 13, a storage device 16. The CPU 11 controls entire operation of the electronic whiteboard 1. The ROM 12 stores various programs. The RAM 13 is a memory to which program and various data are loaded. The storage device 16 stores various programs. The CPU 11, the ROM 12, the RAM 13, and the storage device 16 are connected to each other via a bus. The CPU 11, the ROM 12, and the RAM 13 constitutes a control device 100. In other words, the control device 100 is implemented by the CPU 11 executing a control program that is loaded to the RAM 13 from the ROM 12 or the storage device 16, whereby executes a control operation described below of the electronic whiteboard 1.

The RAM 13 is a volatile memory such as a double data rate (DDR) memory. The RAM 13 expands the control program to be executed by the control device 100 and temporarily stores computation data.

The storage device 16 is implemented by a non-volatile memory such as a hard disc drive (HDD) or a flash memory that retains data stored therein even when the power is turned off. The storage device 16 stores a control program for controlling the electronic whiteboard 1.

The control device 100 is electrically connected to the display device 14 and the camera 15. The touch panel 14a, which is transparent, is laid over the top of the display device 14. Participants in the meeting draw characters, figures, and the like on the touch panel 14a using a dedicated pen, whereby the drawn characters or figures are displayed on the display device 14.

The camera 15 is positioned such that objects in front of the display device 14 of the electronic whiteboard 1 can be imaged. For example, the camera 15 captures the faces of the participants participating in the meeting, who look in the direction of the display device 14. In other words, the camera 15 cannot capture the face of a person (a person who is not a participant in the meeting) who is present on the opposite side (i.e., the back side) of the electronic whiteboard 1 with respect to the display device 14.

The control device 100 is connected to a wireless LAN communication device 18. The wireless LAN communication device 18 is connected to each of the PCs 3 via a network L2. The control device 100 communicates with each of the PCs 3 that connect to the access point via the wireless LAN communication device 18. The control device 100 can transmit and receive data/information to and from the PCs 3. Further, the control device 100 is connected to a LAN communication device 17. The LAN communication device 17 is connected to the authentication server 5 via the communication line L1. The control device 100 communicates with the authentication server 5 via the LAN communication device 17. The control device 100 can transmit and receive data/information to and from the authentication server 5.

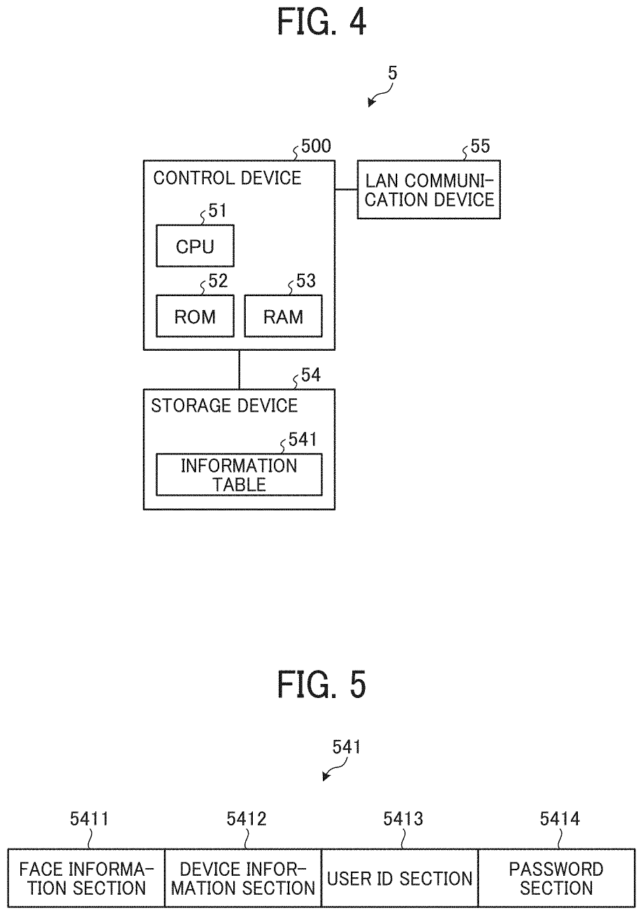

A description is now given of the authentication server 5. FIG. 4 is a block diagram illustrating a hardware configuration of the authentication server 5. As illustrated in FIG. 4, the authentication server 5 includes a CPU 51, a ROM 52, a RAM 53 and a storage device 54. The CPU 51 controls entire operation of the authentication server 5. The ROM 52 stores various programs. The RAM 53 is a memory to which program and various data are loaded. The storage device 54 stores various programs. The CPU 51, the ROM 52, the RAM 53 and the storage device 54 are connected to each other via a bus. The CPU 51, the ROM 52, and the RAM 53 constitutes a control device 500. In other words, the control device 500 is implemented by the CPU 51 executing a control program that is loaded to the RAM 53 from the ROM 52 or the storage device 54, whereby executes a control operation described below of the authentication server 5.

The storage device 54 is implemented by a non-volatile memory such as an HDD or a flash memory that retains data stored therein even when the power is turned off. The storage device 54 stores a control program for controlling the authentication server 5. The storage device 54 includes an information table 541. A detailed description is given later of the information table 541 with reference to FIG. 5.

Further, the control device 500 is connected to a LAN communication device 55. The LAN communication device 55 is connected to the electronic whiteboard 1 via the communication line L1. The control device 500 communicates with the electronic whiteboard 1 via the LAN communication device 55, and can transmit and receive data/information to and from the electronic whiteboard 1.

A description is now given of the information table 541. FIG. 5 is a diagram illustrating a memory structure (data structure) of the information table 541 of the authentication server 5. As illustrated in FIG. 5, the information table 541 includes a face information section 5411, a device information section 5412, a user identification (ID) section 5413, and a password section 5414.

The face information section 5411 stores face information that characterizes a human face. The face information is information including face information (eyes, nose, mouth, ears, chin, etc.) of a human face, for example. One person can be identified based on the face information. For example, the control device 500 of the authentication server 5 extracts face information based on a face image captured by the camera 15. When the extracted face information matches the face information stored in the face information section 5411, the control device 500 of the authentication server 5 identifies the person captured by the camera 15 as a person corresponding to the face information that is stored in the face information section 5411 and matches the extracted face information. The device information section 5412 stores device information for identifying a particular one of the PCs 3 in association with the face information stored in the face information section 5411. The device information is an example of terminal identification information. Examples of the device information include a media access control (MAC) address assigned to each of the PCs 3 and certificate information installed in each of the PCs 3, the certificate information identifying a particular one of the PCs 3 in which the certificate information is installed. In the embodiment, a description is given of an example in which the device information is a MAC address. The MAC address is a unique address assigned to each of the PCs 3. The MAC address identifies a particular one of the PCs 3. The user ID section 5413 stores an ID (identification) of a user for identifying a particular one of the PCs 3, in association with the face information stored in the face information section 5411 and the device information stored in the device information section 5412. The password section 5414 stores passwords that are set in association with the user IDs stored in the user ID section 5413, respectively. Note that the information table 541 stores the face information, the device information, the user ID, and the password, for each of all persons in an organization, such as a company, the persons owning the PCs 3 respectively. The information table 541 does not store face information, device information, user IDs, and passwords of persons outside the company. Note that the face information section 5411 can store a face image including the face information.

Note that the configurations illustrated in FIG. 1 to FIG. 5 are common to the first to fourth embodiments described below.

### First Embodiment

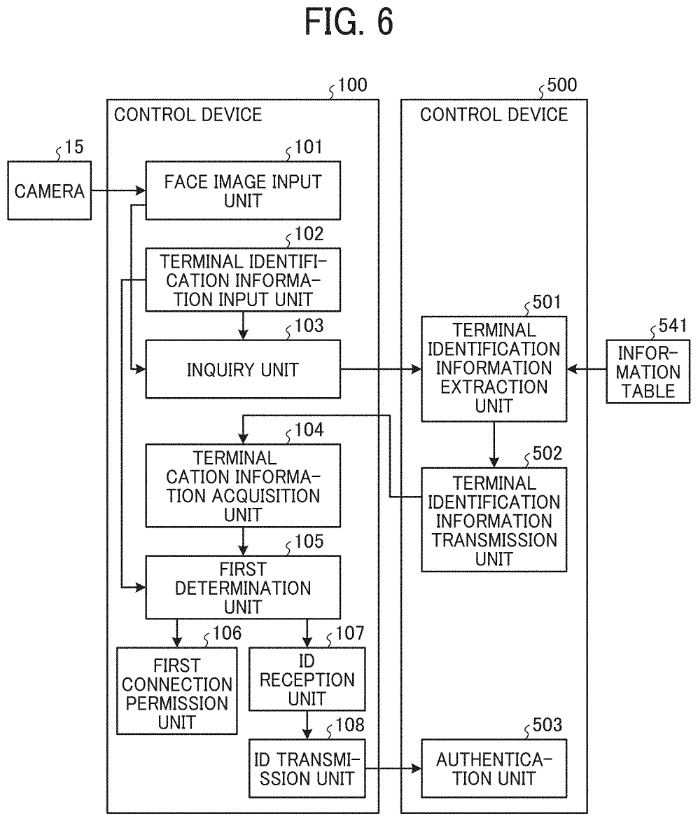

A description is now given of the functional configurations of the electronic whiteboard 1 and the authentication server 5, according to the first embodiment. FIG. 6 is a block diagram illustrating the functional configurations of the electronic whiteboard 1 and the authentication server 5, according to the first embodiment. First, a description is given of the functional configuration of the electronic whiteboard 1. As illustrated in FIG. 6, the control device 100 of the electronic whiteboard 1 executes the control program that is loaded to the RAM 13 from the ROM 12 and/or the storage device 16 to implement functions or processes of a face image input unit 101, a terminal identification information input unit 102, an inquiry unit 103, a terminal information acquisition unit 104, a first determination unit 105, a first connection permission unit 106, an ID reception unit 107 and an ID transmission unit 108. The terminal information acquisition unit 104 is an example of terminal information acquisition means. The first determination unit 105 is an example of first determination means. The first connection permission unit 106 is an example of first connection permission means.

The face image input unit 101 receives an input of a face image captured by the camera 15 from the camera 15 and inputs the received face image to the inquiry unit 103. The terminal identification information input unit 102 receives, from a particular one of the PCs 3 that has sent a connection request to the access point, an input of the device information identifying the particular PC 3 transmitted by the particular PC 3, and inputs the received device information to the first determination unit 105.

In response to the connection request to the access point from the terminal identification information input unit 102, the inquiry unit 103 transmits the face image input by the face image input unit 101 to the authentication server 5. The inquiry unit 103 transmits an inquiry to the authentication server 5 for device information that identifies a particular one of the PCs 3 owned by the meeting participant associated with the face information obtained based on the face image input by the face image input unit 101.

The terminal information acquisition unit 104 receives and acquires device information identifying the particular PC 3 associated with the face information, the device information being transmitted from the authentication server 5 in response to the inquiry from the inquiry unit 103.

The first determination unit 105 compares the device information input by the terminal identification information input unit 102 with the device information received by the terminal information acquisition unit 104 from the authentication server 5 and determines whether the two device information are identical.

When the first determination unit 105 determines that the device information input by the terminal identification information input unit 102 matches the device information received by the terminal information acquisition unit 104 from the authentication server 5, the first connection permission unit 106 permits connection to the access point by the PC 3 that has sent the connection request. The PC 3 that is permitted to connect to the access point can exchange information with the electronic whiteboard 1. Accordingly, a person who owns the PC 3 permitted to connect to the access point can be a participant in the meeting that is held by using the electronic whiteboard 1 when authentication by the authentication server 5 is successful.

When the first determination unit 105 determines that the device information input by the terminal identification information input unit 102 matches the device information received by the terminal information acquisition unit 104 from the authentication server 5, the ID reception unit 107 receives inputs of a user ID and a password of the PC 3.

The ID transmission unit 108 transmits the user ID and password received by the ID reception unit 107 to the authentication server 5.

Note that the control device 100 of the electronic whiteboard 1 also functions as the terminal information acquisition unit 104, the first determination unit 105, and the first connection permission unit 106, which are constituted as the access point. The terminal information acquisition unit 104 is an example of terminal information acquisition means. The first determination unit 105 is an example of first determination means. The first connection permission unit 106 is an example of first connection permission means.

Next, a description is given of the functional configuration of the authentication server 5. The control device 500 of the authentication server 5 executes the control program that is loaded to the RAM 53 from the storage device 54 to implement functions or processes of a terminal identification information extraction unit 501, a terminal identification information transmission unit 502, an authentication unit 503. The authentication unit 503 is an example of authentication means.

In response to an inquiry for device information from the electronic whiteboard 1, the terminal identification information extraction unit 501 acquires face information based on the received face image. The terminal identification information extraction unit 501 extracts device information associated with the face information. Specifically, the terminal identification information extraction unit 501 performs face authentication based on the received face image. More specifically, the terminal identification information extraction unit 501 extracts face information (information on eyes, nose, mouth, ears, chin, etc.) included in the face image and compares the extracted face information with the face information stored in the face information section 5411. Then, the terminal identification information extraction unit 501 identifies face information that matches the face information included in the received face image from among the face information stored in the face information section 5411. Further, the control device 500 extracts device information associated with the identified face information from the device information section 5412.

The terminal identification information transmission unit 502 transmits the device information extracted by the terminal identification information extraction unit 501 to the electronic whiteboard 1.

In response to receiving an authentication request for a particular one of the PCs 3 from the electronic whiteboard 1, the authentication unit 503 compares the received user ID corresponding to the PC 3 with user IDs stored in the user ID section 5413. Further, the authentication unit 503 compares the received password corresponding to the PC 3 with a password stored in the password section 5414 in association with the received user ID. When the authentication unit 503 determines that the received user ID matches any one of the user IDs stored in the user ID section 5413 and the received password matches the password stored in association with the received user ID, the authentication unit 503 authenticates the PC 3.

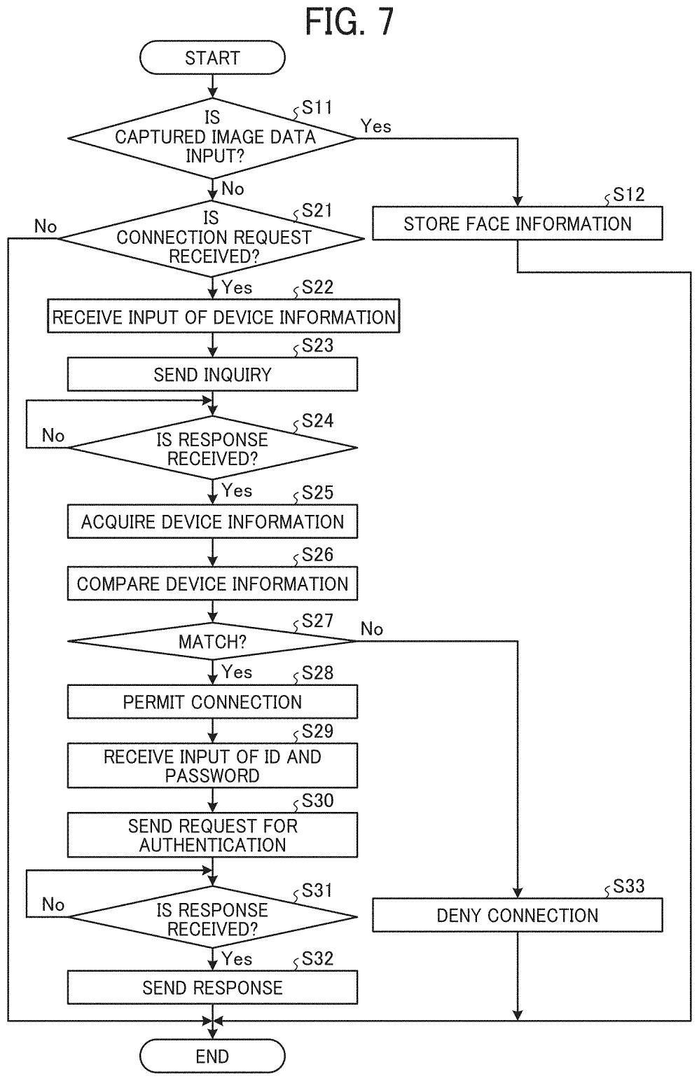

A description is now given of a control operation performed by the electronic whiteboard 1. FIG. 7 is a flowchart illustrating processes in a control operation performed by the electronic whiteboard 1. The face image input unit 101 of the electronic whiteboard 1 determines whether a face image captured by the camera 15 is input (S11). When the face image input unit 101 determines that the face image captured by the camera 15 is input (Yes in S11), the control device 100 stores the input face image in the RAM 13 (S12). Then, the control device 100 ends the operation.

When the face image input unit 101 determines that the face image captured by the camera 15 is not input (No in S11), the control device 100 determines whether a connection request to the access point is received from the PC 3 (S21). This PC 3 is an example of a particular information terminal. When the control device 100 determines that the connection request to the access point is received from the PC 3 (Yes in S21), the terminal identification information input unit 102 receives an input of device information for identifying the PC 3 from the PC 3 that has sent the connection request to the access point and stores the device information in the RAM 13 (S22). This device information of which is input is received in S22 is an example of second particular terminal identification information.

Next, the inquiry unit 103 transmits the face image of which input is received by the face image input unit 101 and stored in the RAM 13 to the authentication server 5, to inquire of the authentication server 5 about device information identifying the PC 3 owned by a meeting participant associated with face information corresponding to the face image (S23). Next, the control device 100 determines whether a response to the inquiry is received from the authentication server 5 (S24). The control device 100 waits until a response to the inquiry is received (No in S24). When the control device 100 determines that a response to the inquiry is received (Yes in S24), the terminal information acquisition unit 104 receives, from the authentication server 5, device information identifying the PC 3 associated with the face information corresponding to the transmitted face image and stores the received device information in the RAM 13 (S25). In other words, the terminal information acquisition unit 104 acquires the device information. This device information acquired in S25 is an example of first particular terminal identification information.

Next, the first determination unit 105 compares the device information of which input is received in S22 with the device information acquired in S25 (S26). Then, the first determination unit 105 determines whether the device information of which input is received in S22 matches the device information acquired in S25 (S27). When the first determination unit 105 determines that the device information of which input is received in S22 matches the device information acquired in S25 (Yes in S27), the first connection permission unit 106 permits the PC 3 that has sent the connection request to connect to the access point (S28).

Next, in response to an authentication request from the PC 3 that sends the connection request, the control device 100 receives an input of a user ID and a password of the PC 3 (S29). Then, the control device 100 transmits the received user ID and password to the authentication server 5 to request authentication (S30). Next, the control device 100 determines whether a response to the authentication request is received (S31). The control device 100 waits until a response to the authentication request is received (No in S31). When the control device 100 determines that a response indicating that the authentication is successful (Yes in S31), the control device 100 transmits information indicating the result to the PC 3 that sends the authentication request (S32). When the control device 100 receives information indicating that the PC 3 is authenticated by the authentication server 5 in S32, the control device 100 transmits information indicating that the PC 3 is authenticated. When the control device 100 receives information indicating that the authentication server 5 denies or rejects the authentication request in S32, the control device 100 transmits information that authentication is refused to the PC 3. Then, the control device 100 ends the operation.

By contrast, when the first determination unit 105 determines that the device information of which input is received in S22 does not match the device information acquired in S25 (No in S27), the control device 100 refuses the PC 3 that has sent the connection request to connect to the access point (S33). Then, the control device 100 ends the operation. Further, when the control device 100 determines in S21 that the connection request to the access point is not received from the PC 3 (No in S21), the control device 100 ends the operation.

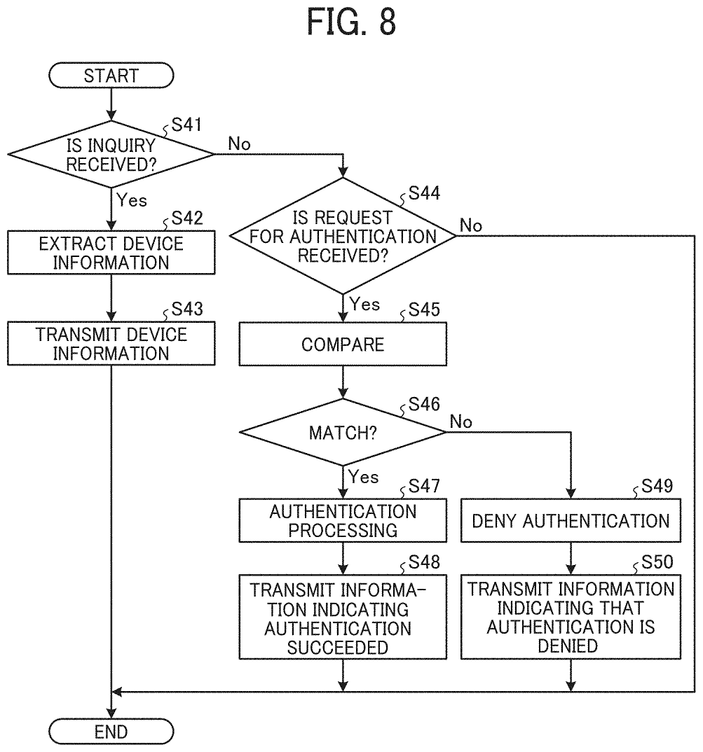

Next, a description is given of a control operation performed by the authentication server 5. FIG. 8 is a flowchart illustrating processes in a control operation performed by the authentication server 5. As illustrated in FIG. 8, the control device 500 of the authentication server 5 receives a face image from the electronic whiteboard 1 and determines whether an inquiry about device information is received (S41). When the control device 500 determines that an inquiry about device information is received (Yes in S41), the terminal identification information extraction unit 501 performs face authentication based on the received face image to acquire face information. The terminal identification information extraction unit 501 extracts, from the device information section 5412, device information associated with the face information stored in the face information section 5411 (S42). Then, the terminal identification information transmission unit 502 transmits the extracted device information to the electronic whiteboard 1 (S43).

When the control device 500 determines that an inquiry about device information is not received (No in S41), the control device 500 determines whether an authentication request for the PC 3 is received from the electronic whiteboard 1 (S44). When the control device 500 determines that the authentication request for the PC 3 is received from the electronic whiteboard 1 (Yes in S44), the control device 500 compares the user ID corresponding to the PC 3 received in S44 with the user IDs stored in the user ID section 5413 (S45). Further, the control device 500 compares the password corresponding to the PC 3 received in S44 with the password stored in a password section 5414 in association with the received user ID (S45). Then, the control device 500 determines whether the received user ID matches with any one of the user IDs stored in the user ID section 5413 and whether the received password matches the password stored in the password section 5414 in association with the received user ID (S46). When the control device 500 determines that both the received user ID and password match the stored user ID and password (Yes in S46), the authentication unit 503 executes the authentication process of the PC 3 based on the received ID and password (S47). Further, the control device 500 transmits, to the electronic whiteboard 1, information indicating that authentication process for the PC 3 has been performed (S48). Then, the control device 500 ends the operation.

By contrast, when the control device 500 determines that either the received user ID or the received password does not match the stored user ID or the stored password, or when neither the received user nor the received password matches the stored user ID and the stored password (No in S46), the authentication unit 503 refuses the authentication process for the PC 3 (S49). Further, the control device 500 transmits, to the electronic whiteboard 1, information indicating that authentication process for the PC 3 has been refused (S50). Then, the control device 500 ends the operation.

When the control device 500 determines that no authentication request is received (No in S44), the control device 500 ends the operation.

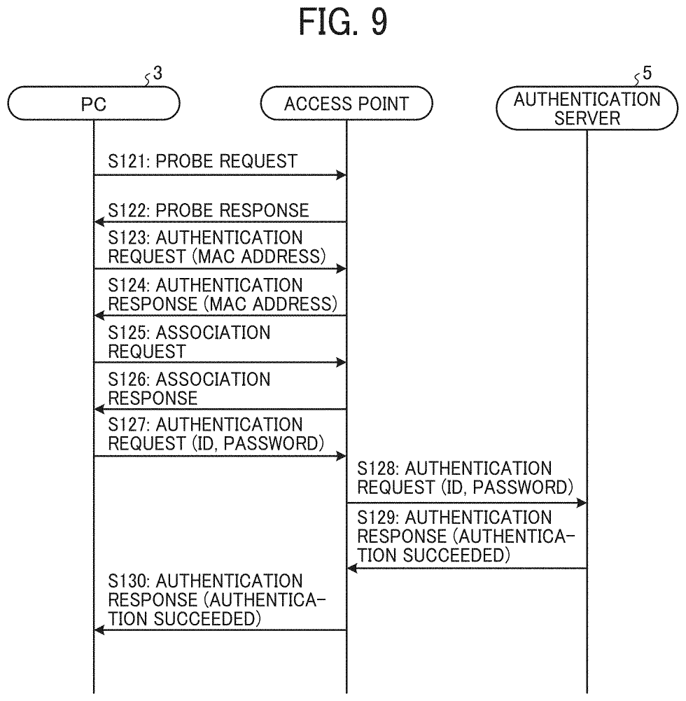

FIG. 9 is a sequence diagram illustrating an example of connection control when connection between the PC 3 and the electronic whiteboard 1 is successful in a communication system according to the present embodiment. In response to detecting that connection to the access point is turned on in the PC 3, a control device of the PC 3 transmits a probe request to the electronic whiteboard 1 (S121). When the probe request is received from the PC 3, the electronic whiteboard 1 returns a probe response to the PC 3 (S122).

In response to receiving the probe response from the electronic whiteboard 1, the PC 3 transmits a connection request to the electronic whiteboard 1 (S123). The connection request includes information of the MAC address of the PC 3 that has transmitted the connection request. The electronic whiteboard 1 determines whether to authenticate connection of the PC 3 by using a predetermined algorithm, and returns an authentication response including the authentication result (S124).

Next, after confirming that the connection has been authenticated by the electronic whiteboard 1, the PC 3 transmits an association (connection) request to the electronic whiteboard 1 (S125). The electronic whiteboard 1 confirms that all parameters included in the association request received from the PC 3 correspond to the electronic whiteboard 1 itself, and then transmits an association response including information indicating that the connection is permitted to the PC 3 (S126).

Through the above processes, a communication path for network connection from the PC 3 via the access point connection is established at the communication network level. In this state, the PC 3 can transmit and receive information to and from the authentication server 5. However, in this state, the user is not yet authenticated by the authentication server 5. In other words, connection is not yet established at the application level.

Next, the PC 3 transmits an authentication request including a user ID and a password to the electronic whiteboard 1 (S127). In response to receiving the authentication request from the PC 3, the electronic whiteboard 1 transmits an authentication request to the authentication server 5 (S128).

In response to receiving the authentication request from the electronic whiteboard 1, the authentication server 5 performs user authentication by referring to the information table 541 for the user ID and the password included in the authentication request. Then, the authentication server 5 transmits an authentication response including the authentication result to the electronic whiteboard 1 (S129). Then, the electronic whiteboard 1 transmits the authentication response received from the authentication server 5 to the PC 3 (S130).

### Second Embodiment

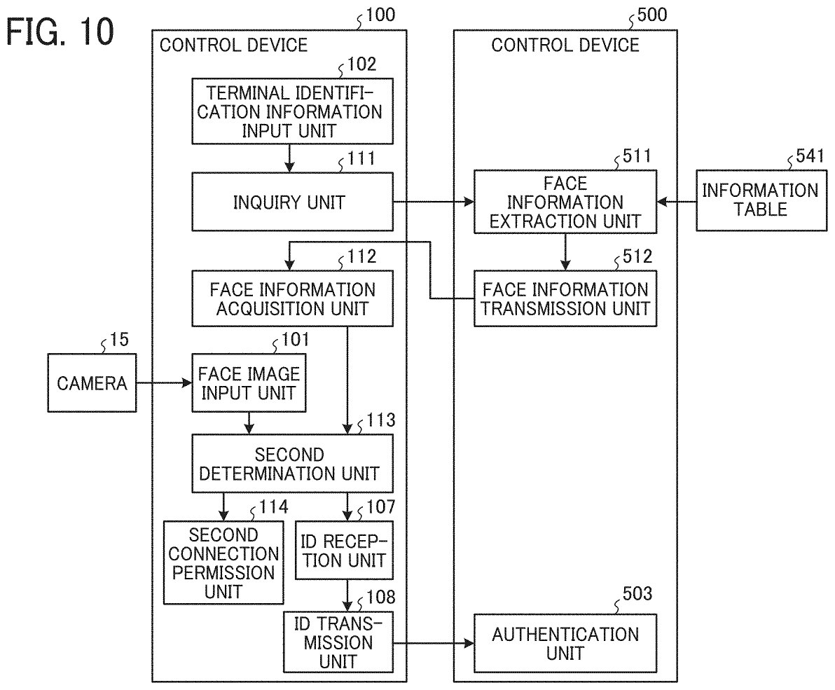

A description is now given of the functional configurations of the electronic whiteboard 1 and the authentication server 5, according to the second embodiment. FIG. 10 is a block diagram illustrating the functional configurations of the electronic whiteboard 1 and the authentication server 5, according to the second embodiment. First, a description is given of the functional configuration of the electronic whiteboard 1 according to the second embodiment. As illustrated in FIG. 10, the control device 100 of the electronic whiteboard 1 executes the control program that is loaded to the RAM 13 from the ROM 12 and/or the storage device 16 to implement functions or processes of the face image input unit 101, the terminal identification information input unit 102, an inquiry unit 111, a face information acquisition unit 112, a second determination unit 113, a second connection permission unit 114, the ID reception unit 107 and the ID transmission unit 108. The face information acquisition unit 112 is an example of face information acquisition means. The second determination unit 113 is an example of second determination means. The second connection permission unit 114 is an example of second connection permission means. Note that the face image input unit 101, the terminal identification information input unit 102, the ID reception unit 107, and the ID transmission unit 108 implement the same or substantially the same functions and processes as those of the first embodiment, and therefore the redundant descriptions thereof are omitted below.

In response to a connection request to the access point from the terminal identification information input unit 102, the inquiry unit 111 transmits, to the authentication server 5, device information of which input is received by the terminal identification information input unit 102, whereby the inquiry unit 111 transmits an inquiry to the authentication server 5 for face information of a meeting participant associated with the device information.

The face information acquisition unit 112 receives and acquires the face information of the meeting participant associated with the transmitted device information, the face information being transmitted from the authentication server 5 in response to the inquiry from the inquiry unit 111.

The second determination unit 113 compares face information included in the face image received by the face image input unit 101 with the face information received by the face information acquisition unit 112 from the authentication server 5, to determine whether the two face information match each other. More specifically, the second determination unit 113 acquires the face information, which is to be compared with the face information transmitted from the authentication server 5, based on a face image captured by the camera 15 and of which input is received by the face image input unit 101. Then, the second determination unit 113 compares the extracted face information with the face information received by the face information acquisition unit 112 from the authentication server 5. Then, the second determination unit 113 determines whether the extracted face information matches the face information received from the authentication server 5.

When the second determination unit 113 determines that the face information included in the face image input by the face image input unit 101 matches the face information included in the face information received by the face information acquisition unit 112 from the authentication server 5, the second connection permission unit 114 permits the PC 3 that has sent the connection request to connect to the access point. The PC 3 that is permitted to connect to the access point can exchange information with the electronic whiteboard 1. A person who owns the PC 3 permitted to connect to the access point can be a participant in the meeting that is held by using the electronic whiteboard 1 when authentication by the authentication server 5 is successful.

Note that the control device 100 of the electronic whiteboard 1 also functions as the face information acquisition unit 112, the second determination unit 113, and the second connection permission unit 114, which are constituted as the access point. The face information acquisition unit 112 is an example of face information acquisition means. The second determination unit 113 is an example of second determination means. The second connection permission unit 114 is an example of second connection permission means.

Next, a description is given of the functional configuration of the authentication server 5 according the second embodiment. The control device 500 of the authentication server 5 executes the control program that is loaded to the RAM 53 from the storage device 54 to implement functions or processes of a face information extraction unit 511, a face information transmission unit 512, and the authentication unit 503. The authentication unit 503 is an example of authentication means.

In response to an inquiry for face information from the electronic whiteboard 1, the face information extraction unit 511 extracts face information associated with device information included in the inquiry. The face information extraction unit 511 searches the information table 541 to extract face information associated with the received device information from the face information section 5411.

The face information transmission unit 512 transmits the extracted face information to the electronic whiteboard 1. The authentication unit 503 implements the same or substantially same function as that of the first embodiment.

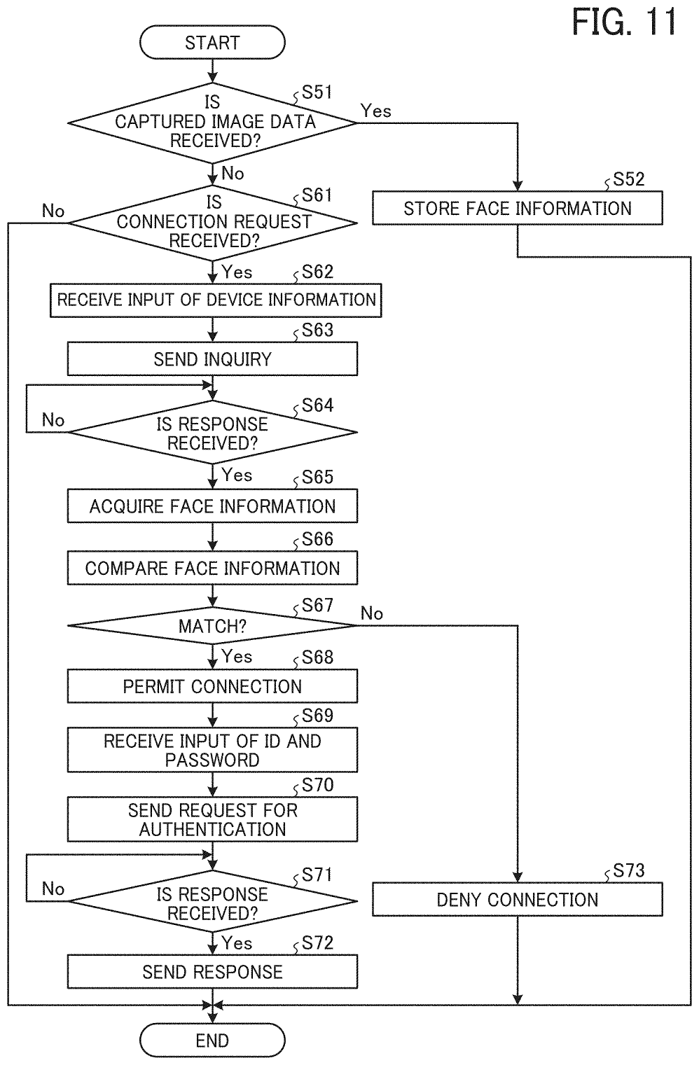

A description is now given of a control operation performed by the electronic whiteboard 1 according to the second embodiment. FIG. 11 is a flowchart illustrating processes in a control operation performed by the electronic whiteboard 1, according to the second embodiment. As illustrated in FIG. 11, the face image input unit 101 of the electronic whiteboard 1 determines whether a face image captured by the camera 15 is input (S51). When the face image input unit 101 determines that the face image captured by the camera 15 is input (Yes in S51), the control device 100 stores the input face image in the RAM 13 (S52). Then, the control device 100 ends the operation.

By contrast, when the face image input unit 101 determines that the face image captured by the camera 15 is not input (No in S51), the control device 100 determines whether a connection request to the access point is received from the PC 3 (S61). When the control device 100 determines that the connection request to the access point is received from the PC 3 (Yes in S61), the terminal identification information input unit 102 receives an input of device information for identifying the PC 3 from the PC 3 that has sent the connection request to the access point and stores the device information in the RAM 13 (S62).

Next, the inquiry unit 111 transmits, to the authentication server 5, the device information of which input is received by the terminal identification information input unit 102 and stored in the RAM 13, to inquire of the authentication server 5 about face information associated with the device information (S63). Next, the control device 100 determines whether a response to the inquiry is received from the authentication server 5 (S64). The control device 100 waits until a response to the authentication request is received (No in S64). When the control device 100 determines that a response to the inquiry is received (Yes in S64), the face information acquisition unit 112 receives, from the authentication server 5, face information associated with the transmitted device information and stores the received face information in the RAM 13 (S65). In other words, the face information acquisition unit 112 acquires the face information.

Next, the second determination unit 113 compares face information obtaining by performing face authentication based on the face image stored in S52 with the face information acquired in S65 (S66). Then, the second determination unit 113 determines whether the face information obtained by performing face authentication matches the face information acquired in S65 (S67). When the second determination unit 113 determines that the face information obtained by performing face authentication matches the face information acquired in S65 (Yes in S67), the second connection permission unit 114 permits the PC 3 that has sent the connection request to connect to the access point (S68). The subsequent processes in S69 to S73 are the same or the substantially the same as the processes in S29 to S33 of FIG. 7, and therefore the redundant descriptions thereof are omitted below. Further, when the control device 100 determines in S61 that the connection request to the access point is not received from the PC 3 (No in S61), the control device 100 ends the operation.

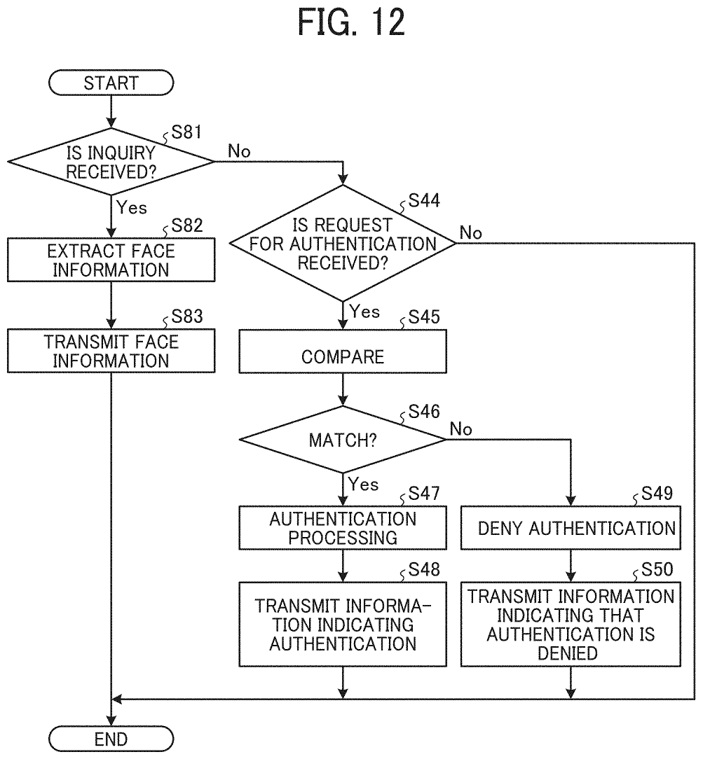

A description is now given of a control operation performed by the authentication server 5, according to the second embodiment. FIG. 12 is a flowchart illustrating processes in a control operation performed by the authentication server 5, according to the second embodiment. In FIG. 12, the same or corresponding processes as those in the operation described above with reference to FIG. 8 are denoted by the same step numbers of FIG. 8, and the redundant descriptions thereof are omitted below. As illustrated in FIG. 12, the control device 500 of the authentication server 5 receives device information from the electronic whiteboard 1 and determines whether an inquiry about face information is received (S81). When the control device 500 determines that an inquiry about face information is received (Yes in S81), the face information extraction unit 511 extracts, from the face information section 5411, face information stored in association with the device information stored in the device information section 5412, based on the received device information (S82). Then, the face information transmission unit 512 transmits the extracted face information to the electronic whiteboard 1 (S83). Then, the control device 500 ends the operation.

By contrast, when the control device 500 determines that an inquiry about device information is not received (No in S81), the control device 500 performs the processes of S44 to S50 described above with FIG. 8.

### Third Embodiment

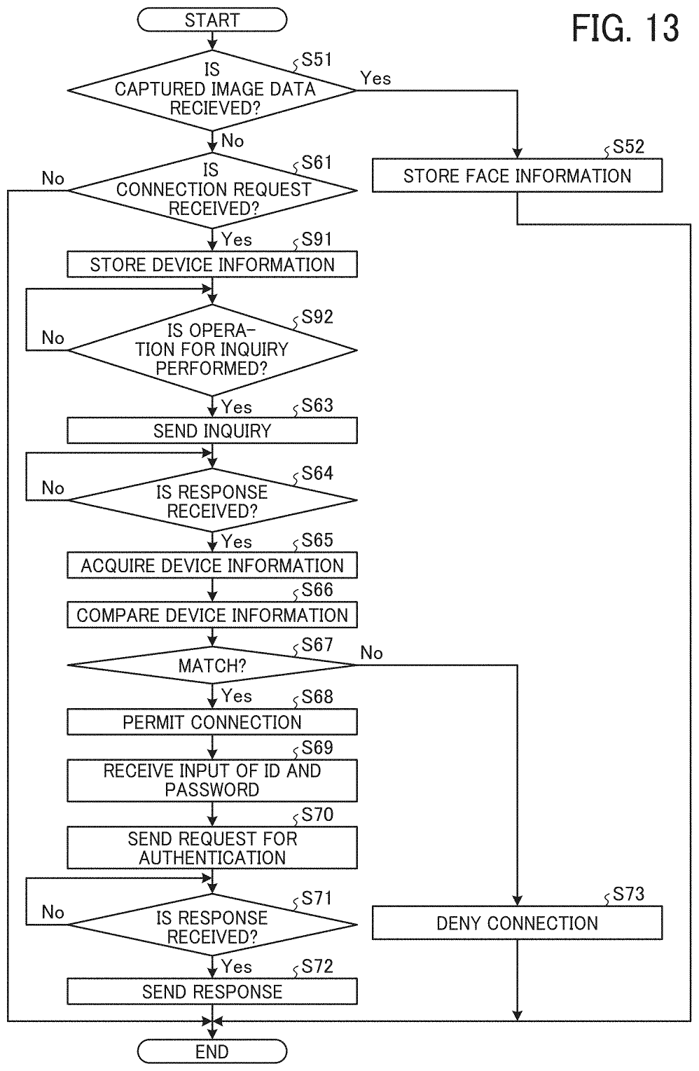

A description is now given of the third embodiment. The third embodiment is different from the second embodiment in the following points. Specifically, in the second embodiment, every time a connection request is received in S61, an inquiry is made as to whether the PC 3 that has sent a connection request is permitted to connect to the access point. On the other hand, in the third embodiment, an inquiry about connection permission is made collectively for all the PCs 3 that have sent connection requests. FIG. 13 is a flowchart illustrating processes in a control operation performed by the electronic whiteboard 1, according to the third embodiment. In FIG. 13, the same or corresponding processes as those in the operation described above with reference to FIG. 11 are denoted by the same step numbers of FIG. 11, and the redundant descriptions thereof are omitted below.

As illustrated in FIG. 13, when a connection request is received from the PC 3 in S61, the control device 100 stores device information received from the PC 3 in the RAM 13 (S91). More specifically, the control device 100 stores, in the RAM 13, all device information identifying the PCs 3 that have sent connection requests. Next, the control device 100 determines whether an operation for inquiring face information is performed (S92). For example, a software key that receives an operation for making an inquiry about face information is provided on the touch panel 14a. The control device 100 waits until an operation for inquiring the face information is performed (No in S92). When the control device 100 determines that the operation for inquiring the face information is performed (Yes in S92), the control device 100 executes the processes of S63 and subsequent steps.

### Fourth Embodiment

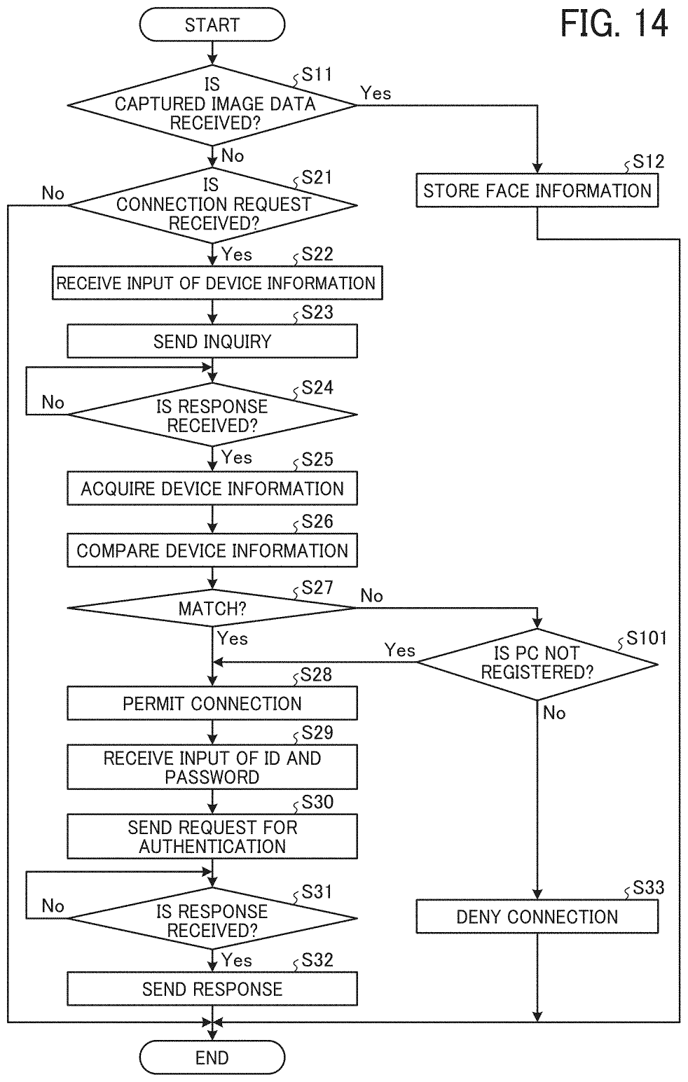

A description is now given of the fourth embodiment. The fourth embodiment is different from the first embodiment in the following points. Specifically, in the fourth embodiment, the PC 3 owned by a guest (e.g., a person outside the company) who participates in the meeting can connect to the access point. FIG. 14 is a flowchart illustrating processes in a control operation performed by the electronic whiteboard 1, according to the fourth embodiment. In FIG. 14, the same or corresponding processes as those in the operation described above with reference to FIG. 7 are denoted by the same step numbers of FIG. 7, and the redundant descriptions thereof are omitted below.

As illustrated in FIG. 14, when the first determination unit 105 determines in S27 that the device information input in S22 and the device information acquired in S25 do not match each other (No in S27), the control device 100 determines whether the PC 3 that has sent the connection request is a PC 3 whose device information is not registered (S101). The control device 100 determines whether the PC 3 is a PC whose device information is not registered based on whether the control device 100 has received non-registration information indicating a non-registered device information from the authentication server 5. A detailed description is given later of the non-registration information.

When the control device 100 determines that the PC 3 that has sent the connection request is non-registered PC 3 (Yes in S101), the control device 100 permits the PC 3 to connect to the access point. The control device 100 determines that the PC 3 for which the non-registration information is received is the PC 3 that is not registered in the company and that is owned by the guest. Accordingly, the control device 100 permits such PC 3 to connect to the access point (S28).

By contrast, when the control device 100 determines that the PC 3 that has sent the connection request is not a non-registered PC 3 (that is, the PC 3 of an in-house person registered in the information table 541 but of a person who is not a participant in the meeting) (No in S101), the control device 100 executes the process of S33.

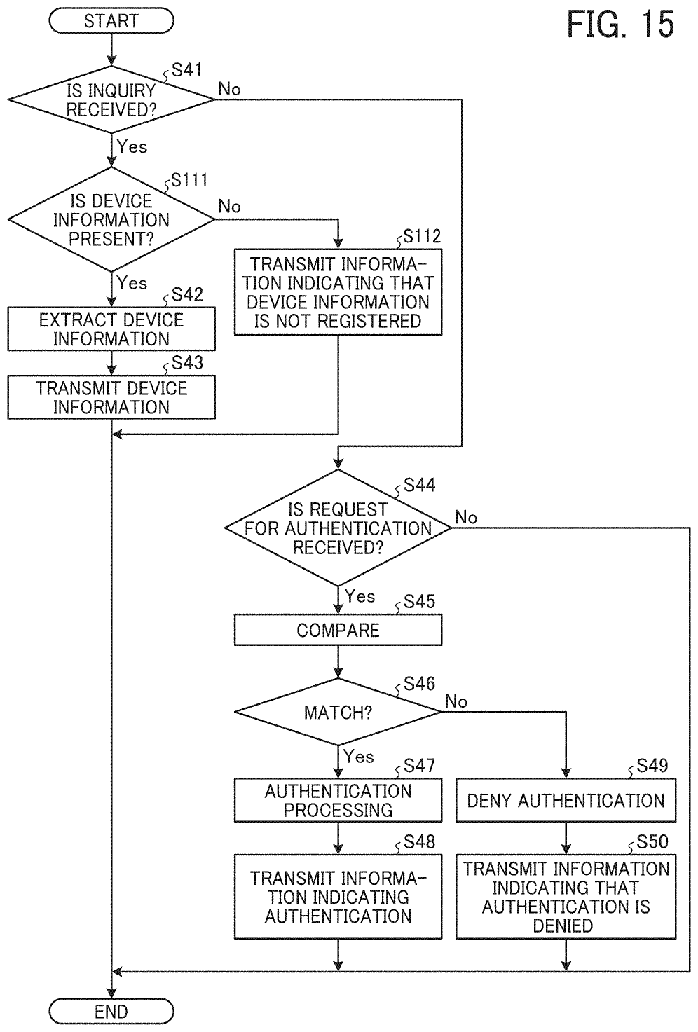

A description is now given of a control operation performed by the authentication server 5, according to the fourth embodiment. FIG. 15 is a flowchart illustrating processes in a control operation performed by the authentication server 5, according to the fourth embodiment. In FIG. 15, the same or corresponding processes as those in the operation described above with reference to FIG. 8 are denoted by the same step numbers of FIG. 8, and the redundant descriptions thereof are omitted below. As illustrated in FIG. 15, when the control device 500 of the authentication server 5 determines that an inquiry about device information is received from the electronic whiteboard 1 (Yes in S41), the control device 500 searches the information table 541 to determine whether there is device information associated with face information extracted based on the received face image in the device information section 5412 (S111). When the control device 500 determines that there is the associated device information in the device information section 5412 (Yes in S111), the control device 500 executes the processes of S42 and subsequent steps. By contrast, when the control device 500 determines that there is no associated device information in the device information section 5412 (No in S111), The control device 500 transmits non-registration information indicating that there is no device information associated with the received face information to the electronic whiteboard 1 (S112). Then, the control device 500 ends the operation.

### Fifth Embodiment

In the fifth embodiment, the access point transmits a participant's face image captured by the camera and a user ID and password input by the participant to the authentication server 5. The authentication server 5 compares the received face image of the participant with the face information stored in the face information section 5411. The authentication server 5 identifies face information that matches the face information included in the received face image from among the face information stored in the face information section 5411. Further, the authentication server 5 extracts device information associated with the identified face information from the device information section 5412. Finally, when both the user ID and password received from the access point match the user ID and password of the device extracted from the device information section 5412, the authentication server 5 authenticates the information terminal and permits use of the network.

As described heretofore, according to one or more embodiments of the present disclosure, when device information obtained based on a face image of a participant attending a meeting imaged by the camera matches device information obtained from the PC 3 that has sent a connection request, connection by the PC 3 to the access point is permitted. Therefore, only the PC 3 (PCs 3) owned by the participant(s) in the meeting can use the network L2.

Further, according to one or more embodiments, when face information obtained from a face image of a participant attending a meeting imaged by the camera matches face information obtained based on the PC 3 that has sent a connection request, connection by the PC 3 to the access point is permitted. Therefore, only the PC 3 (PCs 3) owned by the participant(s) in the meeting can use the network L2.

Further, according to one or more embodiments, since the access point for connecting the PC 3 is a function of the electronic whiteboard 1, only the PC 3 (PCs) owned by the participant(s) in the meeting that is held by using the electronic whiteboard 1 can use the network L2.

Further, according to one or more embodiments, in a case where the access point that connects the PC 3 is a function of a videoconferencing apparatus, only the PC 3 (PCs 3) owned by the participant(s) in a meeting that is held by using the videoconferencing apparatus can use the network L2.

Although in the embodiments, the description given heretofore is of a case where the electronic whiteboard 1 includes a function as an access point, this is just an example. In another example, a videoconferencing apparatus can be used as an access point, the videoconferencing apparatus including a video reproducing function and conducting a meeting with one or more PCs 3 connected to the videoconferencing apparatus while displaying video information or the like on its display. In this case, the videoconferencing apparatus permits the PC 3 (PCs 3) owned by the participant(s) in the meeting to connect to the access point.

Further, although in the embodiments, the description given heretofore is of a case where the authentication server 5 includes the information table 541, this is just an example. In another example, the electronic whiteboard 1 or the videoconferencing apparatus can include the information table 541.

Furthermore, in the embodiments, the description given heretofore is of a case where the PC 3 is an example of an information terminal. Alternatively, the information terminal can be implemented by a mobile device.

The program executed by the electronic whiteboard 1 and the authentication server 5 according to each embodiment can be stored in a computer readable storage medium, such as a compact disc read only memory (CD-ROM), a flexible disk (FD), a compact disc recordable (CD-R), and a digital versatile disk (DVD), in an installable or executable file format, for distribution.

Furthermore, the program executed by the electronic whiteboard 1 and the authentication server 5 according to each embodiment can be stored in a computer connected to a network such as the Internet and downloaded via the network. Further, the program executed by the electronic whiteboard 1 and the authentication server 5 according to the present embodiment can be provided or distributed via a network, such as the Internet.

The program executed by the electronic whiteboard 1 and the authentication server 5 according to each embodiment has a module configuration including the above-described units (the face image input unit 101, the terminal identification information input unit 102, the inquiry unit 103, the terminal information acquisition unit 104, the first determination unit 105, the first connection permission unit 106, the ID reception unit 107, the ID transmission unit 108, the terminal identification information extraction unit 501, the terminal identification information transmission unit 502, the authentication unit 503, the inquiry unit 111, the face information acquisition unit 112, the second determination unit 113, the second connection permission unit 114, the face information extraction unit 511, and the face information transmission unit 512). As actual hardware, a CPU (processor) reads out the program from the ROM and executes the program, so that each of the above-described units is loaded on the main memory, and the face image input unit 101, the terminal identification information input unit 102, the inquiry unit 103, the terminal information acquisition unit 104, the first determination unit 105, the first connection permission unit 106, the ID reception unit 107, the ID transmission unit 108, the terminal identification information extraction unit 501, the terminal identification information transmission unit 502, the authentication unit 503, the inquiry unit 111, the face information acquisition unit 112, the second determination unit 113, the second connection permission unit 114, the face information extraction unit 511, and the face information transmission unit 512 are generated on the main memory.

According to the conventional art, an information terminal of a person other than a participant in a remote conference can connect to the access point, if user identification information of the person is registered in advance.

According to one or more embodiments of the present disclosure, only an information terminal(s) of a person(s) participating in a meeting can connect to an access point. Accordingly, for example, processing load on the access point is reduced.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A network system comprising:
a memory to store an information table storing a plurality of terminal identification information identifying a plurality of information terminals respectively in association with a plurality of face information;
an authentication server disposed on a network;
a camera; and
an access point that allows one or more of the plurality of information terminals to connect to the network,
the access point comprising first circuitry configured to:
in response to receiving a connection request to the network from a particular information terminal, determine whether there is association between information obtained based on a face image captured by the camera and information acquired from the particular information terminal that has sent the connection request; and
permit the particular information terminal that has sent the connection request to connect to the network based on determination that there is the association,
the authentication server comprising second circuitry configured to perform an authentication process for the particular information terminal that is permitted to connect to the network.

2. The network system of claim 1,
wherein the first circuitry of the access point is further configured to:
in response to receiving the connection request to the network from the particular information terminal, acquire, from the information table, first particular terminal identification information corresponding to face information obtained based on the face image captured by the camera;
determine whether the first particular terminal identification information acquired from the information table matches second particular terminal identification information identifying the particular information terminal that has sent the connection request, the second particular terminal identification information being acquired from the particular information terminal in response receiving to the connection request; and
permit the particular information terminal that has sent the connection request to connect to the network based on determination that the first particular terminal identification information acquired from the information table matches the second particular terminal identification information identifying the particular information terminal that has sent the connection request.

3. The network system of claim 1,
wherein the first circuitry of the access point is further configured to:
in response to receiving the connection request to the network from the particular information terminal, acquire, from the information table, first particular face information corresponding to particular terminal identification information identifying the particular information terminal, the particular terminal identification information being acquired from the particular information terminal in response to receiving the connection request;
determine whether the first particular face information acquired from the information table matches second particular face information that is obtained based on the face image captured by the camera; and
permit the particular information terminal that has sent the connection request to connect to the network based on determination that the first particular face information acquired from the information table matches the second particular face information that is obtained based on the face image captured by the camera.

4. The network system of claim 1,
wherein the camera and the access point are included in an electronic whiteboard.

5. The network system of claim 1,
wherein the camera and the access point are included in a videoconferencing apparatus.

6. An information processing apparatus connected to a network, the information processing apparatus including an access point configured to:
in response to receiving a connection request to the network from a particular information terminal, determine whether there is association between first information obtained based on a face image captured by a camera and second information acquired from the particular information terminal that has sent the connection request, the first information being acquired from a memory configured to store an information table storing a plurality of terminal identification information identifying a plurality of information terminals respectively in association with a plurality of face information; and
permit the particular information terminal that has sent the connection request to connect to the network based on determination that there is the association.

7. An authentication method performed by an information processing apparatus connected to a network, the information processing apparatus including an access point, the method comprising:
in response to receiving a connection request to the network from a particular information terminal, determining whether there is association between first information obtained based on a face image captured by a camera and second information acquired from the particular information terminal that has sent the connection request, the first information being acquired from a memory configured to store an information table storing a plurality of terminal identification information identifying a plurality of information terminals respectively in association with a plurality of face information; and
permitting the particular information terminal that has sent the connection request to connect to the network based on determination that there is the association.
